(19) United States
(12) Patent Application Publication
(10) Pub. No.: US 2008/0141677 A1
(43) Pub. Date: Jun. 19, 2008

(54) Axial tangential radial on-board cooling air injector for a gas turbine

(75) Inventor: Dieter Brillert, Rodgau (DE)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/639,859

(22) Filed: Dec. 15, 2006

(51) Int. Cl. F02C 6/08

(52) U.S. Cl. 60/785

(57) ABSTRACT

A circular array of generally L-shaped flow paths (28) in an injector housing (32, 34) encircling a gas turbine rotor (24), each of the flow paths having an inflow leg (28A ) oriented generally radially with respect to the rotor axis (58), and an outflow leg (28B) oriented partly axially and partly tangentially. An adjustment plate (50) may be attached to the injector (20) at an adjustable position (52) to partially block an inflow passage (38) of the injector in order to adjust the flow of cooling air (27) through the respective flow path.

### FIELD OF THE INVENTION

The invention relates to non-rotating nozzles or vanes for injecting cooling air into a channel in a gas turbine rotor, and directing the air from the injector outlets so as to match rotation of the rotor cooling channel inlet.

### BACKGROUND OF THE INVENTION

Cooling air for a gas turbine engine may be drawn from the turbine compressor section in piping that bypasses the combustors. Tangential On-Board Injector (TOBI) devices inject the cooling air into channels in the rotor of the turbine section. It may flow through the turbine shaft, then outward through passages in the turbine disks and blades, where it may exit into the working gas. Various injector designs have been used to direct cooling air from non-rotating injector outlets into rotating cooling channel inlets in the turbine rotor. Some designs use holes or bores as nozzles, and others use airfoil type nozzles, or vanes, that define cooling flow paths between them. However, according to U.S. Pat. No. 6,379,117 issued to Ichiryu on Apr. 30, 2000, it is extremely difficult to incline airfoil type nozzles to the tangential direction and to the axial direction simultaneously.

### BRIEF DESCRIPTION OF THE DRAWINGS

The invention is explained in following description in view of the drawings that show:

FIG. 1 is a sectional view of an injector according to aspects of the invention taken along a plane of the gas turbine rotor axis.

FIG. 2 is a partial perspective view of the injector housing and vanes of FIG. 1.

FIG. 3 is a top view of a planar generally L-shaped vane similar to the ones used in FIGS. 1 and 2.

FIG. 4 is a top view of a generally L-shaped vane with a flat inflow leg and a curved outflow leg.

FIG. 5 is a sectional view of an aspect of the invention using vanes in an annular outflow area of an annular flow passage.

FIG. 6 is a partial perspective view of the injector housing and vanes of FIG. 5.

### DETAILED DESCRIPTION OF THE INVENTION

The inventor recognized that a tangential on-board injector with a circular array of generally L-shaped flow paths could provide an axial-tangential outflow for efficiency, and could use airfoil type nozzles, or vanes, thus overcoming the difficulty mentioned by Ichiryu. This would maximize fluid dynamic efficiency, and minimize manufacturing cost. The terms “axial” and “radial” herein relate to a turbine rotor axis and radii thereof. The term “tangential” herein means tangent to a circle of rotation of a point on the turbine rotor. The term “generally L-shaped flow path” herein means a flow path with two mutually generally orthogonal portions. The term “L-shaped vane” herein means an airfoil with a generally “L-shaped” profile as viewed facing the pressure or suction surface of the airfoil. The corner of the “L” shape may be highly curved. The inventor also recognized that a simple adjustment mechanism could be provided on the injector to optimize the cooling flow rate for each installation without custom machining of the injector.

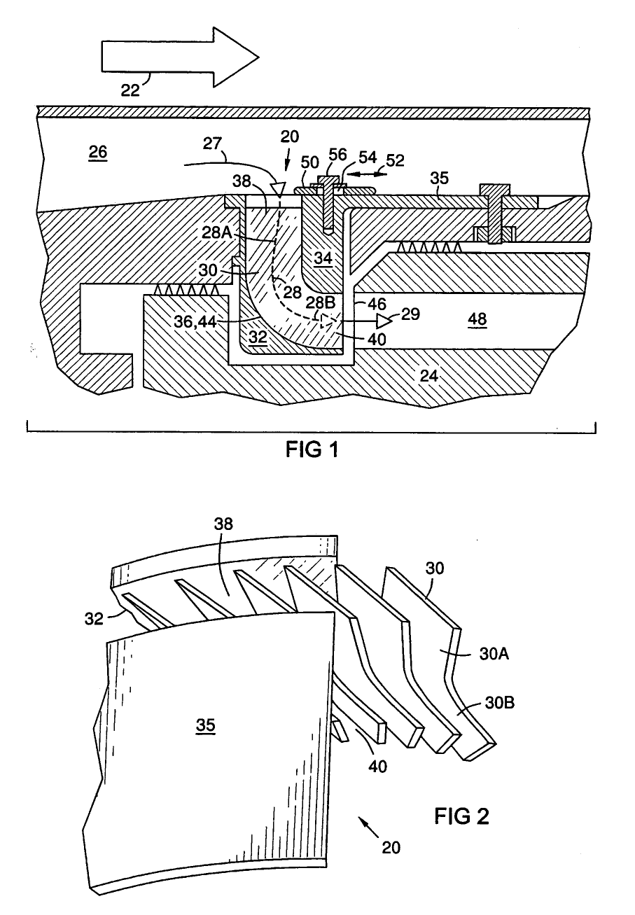

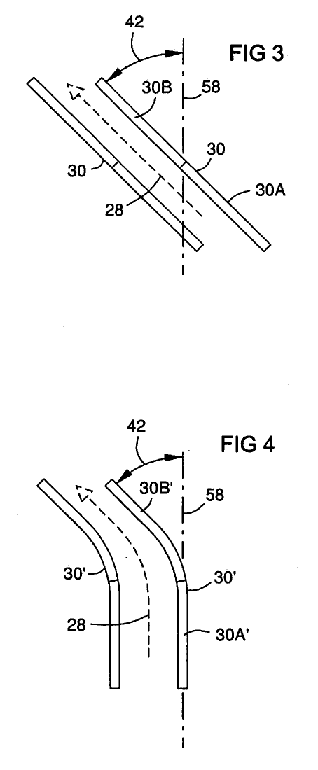

FIG. 1 is a sectional view of a cooling air injector 20 according to aspects of the invention. A hot working gas 22 from combustors drives a gas turbine rotor 24. Cooling passages or pipes 26 provide fluid for the injector inflow 27. This fluid may be air drawn from the turbine main compressor, bypassing the combustors as known in the art, and/or it may be a gas obtained from or mixed with other engine sources as known in the art. The injector 20 may have an annular flow passage 36 formed between two annular walls 32, 34. An injector mounting portion or flange 35 may provide for attachment bolts. Generally L-shaped flow paths 28 are defined by generally L-shaped sectional profiles of the annular flow passage 36 between vanes 30, as seen for example in FIG. 1. Each flow path 28 may have a generally radial inflow leg 28A and an axial-tangential outflow leg 28B. The annular flow passage 36 may have a generally radially oriented annular inflow passage 38 and a generally axially oriented annular outflow passage 40. Generally L-shaped vanes 30 may form a circular array of vanes 30 within the annular flow passage 36. The annular walls 32 and 34 span and interconnect the vanes 30. As shown in FIGS. 2 and 3, the vanes 30 and flow paths 28 may be angled 42 as if pivoted about a radius of the rotor axis. The corner 44 of the “L” shaped sectional profile of flow passage 36 causes a redirection of the cooling flow path 28 from radial to axial. The angle 42 of the vanes 30 provides a partial redirection to tangential. The cooling air outflow 29 is thus partly axial and partly tangential. The injector outflow rate and tangential angle 42 may be engineered such that the tangential component of the outflow 29 approximately matches the rotation speed of cooling channel inlets 46 in the rotor 24. Thus, cooling air 29 entering the rotor cooling channels 48 will not cause drag on the rotor, but will merge with the rotating cooling channel inlets 46 and move into the cooling channels 48. The injector outflow 29 initially forms a generally helical flow pattern until it is otherwise directed or released from the cooling channels 48.

As also shown in FIG. 1 is a flow adjustment plate 50 that may be provided to variably partially cover the inflow passage 38. For example, the injector may be installed with the adjustment plate 50 positioned 52 to provide 10-20% inflow blockage. After running the gas turbine, the cooling air supply pressure and other parameters can be measured, and appropriate positional adjustment 52 of the flow adjustment plate 50 can be made to meet cooling specifications. The adjustment plate 50 may be formed as two or more arcuate segments with axially oriented slots 54 fixed by bolts 56.

FIG. 2 illustrates in partial perspective an embodiment of the invention with flat, generally L-shaped vanes 30, each with a radial inflow leg 30A and an axial-tangential outflow leg 30B. A top view of such a vane 30 is illustrated in FIG. 3, which shows an angle 42 of the vane 30 with respect to the rotor axis 58 that provides a tangential component to the outflow 29 in the direction of rotor rotation. FIG. 4 illustrates an alternate vane 30′ with a flat inflow leg 30A′ and a curved outflow leg 30B′. Either or both legs of a generally L-shaped vane may be angled and/or curved toward the direction of rotor rotation.

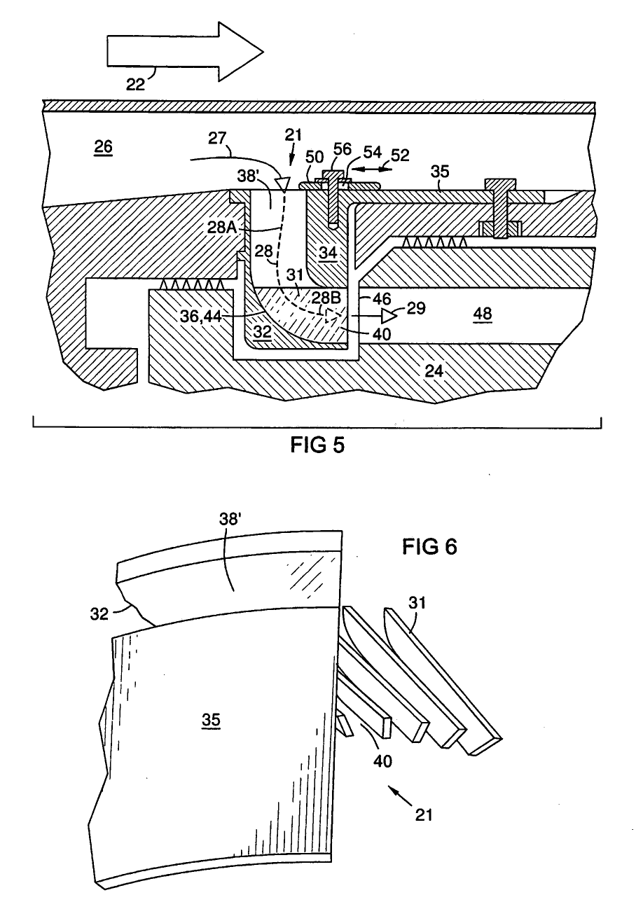

FIGS. 5 and 6 illustrate an injector embodiment 21 with axial-tangential vanes 31 extending in the outflow passage 40 only of the injector flow passage 36. The annular inflow passage in this embodiment is an annular plenum 38′ incorporating all of the radial inflow legs 28A but containing no vane, with the annular plenum directing the cooling air into the spaces between the vanes 31. Generally L-shaped flow paths 28 pass between the vanes 31 as seen in FIG. 5. The vanes 31 are oriented partly axially and partly tangentially. The vanes may be planar as shown, or curved.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A cooling fluid injector for a gas turbine rotor, the cooling fluid injector comprising a circular array of vanes, each vane comprising a generally radial inflow portion and a generally axial outflow portion, wherein at least the outflow portion is angled partly tangentially and partly axially, the vanes defining flow paths between them for cooling air.

2. The cooling fluid injector of claim 1, further comprising an adjustment plate attached to the injector at an adjustable position to selectively partially block an inflow passage of the injector in order to adjust a flow of cooling fluid.

3. The cooling fluid injector of claim 2, wherein the adjustment plate is an arcuate plate attached to an arcuate flange on the injector adjacent the inflow passage of the injector.

4. A cooling fluid injector for a gas turbine rotor, the cooling fluid injector comprising generally L-shaped vanes, each vane comprising a generally radial portion and an axial-tangential portion, wherein the generally radial portion of the vane is disposed between first and second axially spaced wall surfaces, the axial-tangential portion of the vane is disposed between first and second radially spaced wall surfaces, and the axial-tangential portion of the vane is oriented partly axially and partly tangentially with respect to the rotor.

5. A cooling fluid injector for a gas turbine rotor, the cooling fluid injector comprising a circular array of generally L-shaped flow paths in an injector housing that encircles a gas turbine rotor, each of the flow paths comprising an inflow leg oriented generally radially with respect to a rotor axis, and an outflow leg oriented partly axially and partly tangentially.

6. The cooling fluid injector of claim 5, further comprising an arcuate plate attached to the injector at an axially adjustable position to partially block an inflow passage of the injector in order to adjust a fluid flow rate there through.

7. The cooling fluid injector of claim 5, wherein the generally L-shaped flow paths are formed between generally L-shaped vanes in a circular array of said generally L-shaped vanes, and the injector housing comprises two annular walls that interconnect and span the generally L-shaped vanes, enclosing the generally L-shaped flow paths between an inflow passage of the injector and an outflow passage of the injector.

8. The cooling fluid injector of claim 7, further comprising an arcuate plate attached to the injector at an adjustable position to adjustably partially block the generally L-shaped flow paths in order to adjust a fluid flow rate there through.

9. The cooling fluid injector of claim 8, wherein the arcuate plate is adjustable axially to partially block the inflow passage of the injector.

10. The cooling fluid injector of claim 5, wherein the generally L-shaped flow paths are formed by generally L-shaped sectional profiles of an annular flow passage formed between two annular walls of the injector, the annular flow passage comprising a generally radially oriented inflow plenum and a generally axially oriented annular outflow passage, and the outflow legs of the generally L-shaped flow paths are formed between vanes in a circular array of vanes extending only in the generally axially oriented annular outflow passage, the vanes oriented partly axially and partly tangentially.

11. The cooling fluid injector of claim 5, wherein the generally L-shaped flow paths are formed between generally planar L-shaped vanes in a circular array of said generally planar L-shaped vanes, each generally planar L-shaped vane oriented partly axially, partially tangentially, and comprising a generally radially oriented portion bounding the inflow leg of the generally L-shaped flow path.

12. The cooling fluid injector of claim 5, wherein the generally L-shaped flow paths are formed between generally L-shaped vanes in a circular array of said generally planar L-shaped vanes, each generally planar L-shaped comprising a first generally radially oriented portion bounding the inflow leg of the generally L-shaped flow path and a second portion that curves to a partly axial and partly tangential orientation bounding the outflow leg of the generally L-shaped flow path.
